(19) United States
(12) Patent Application Publication
(10) Pub. No.: US 2025/0363836 A1
(43) Pub. Date: Nov. 27, 2025

(54) CONTEXTUAL ROOT CAUSE ANALYSIS FOR VEHICLE SOFTWARE SYSTEMS

(71) Applicant: GM Global Technology Operations LLC, Detroit, MI (US)

(72) Inventors: Alaa M. Khamis, Courtice (CA); Abhishek Kumar Dubey, Toronto (CA); Ramesh S, Troy, MI (US); Aaron Wolf, Chapel Hill, NC (US)

(21) Appl. No.: 18/672,803

(22) Filed: May 23, 2024

(51) Int. Cl. G07C 5/08; G06F 11/07; G07C 5/00

(52) U.S. Cl. CPC G07C 5/0816; G06F 11/0739; G06F 11/079; G06F 11/0793; G07C 5/008

(57) ABSTRACT

A method of diagnosing a software system of a vehicle includes receiving data related to the software system of the vehicle, identifying an anomalous event based on a pattern of the received data, and collecting contextual information related to the anomalous event. The method also includes inputting the anomalous event and the contextual information to a machine learning model, determining a root cause of the anomalous event by the machine learning model, and based on determining that the anomalous event corresponds to the malfunction, performing a mitigating action.

### INTRODUCTION

The subject disclosure relates to fault or failure detection, and more particularly to diagnosis of root causes of anomalous signals.

Many modern vehicles (e.g., cars, motorcycles, boats, or any other types of automobile) include control systems that represent a complex integration of hardware and software components. Such control systems utilize information from many sources (e.g., sensors and control units) to monitor and control vehicle operations, and provide various features. As such, vehicles can rely on sophisticated software architectures, which are monitored to ensure proper operations and identify malfunctions, failures and other problems.

### SUMMARY

In one exemplary embodiment, a method of diagnosing a software system of a vehicle includes receiving data related to the software system of the vehicle, identifying an anomalous event based on a pattern of the received data, and collecting contextual information related to the anomalous event. The method also includes inputting the anomalous event and the contextual information to a machine learning model, determining a root cause of the anomalous event by the machine learning model, and based on determining that the anomalous event corresponds to a malfunction, performing a mitigating action.

In addition to one or more of the features described herein, identifying the anomalous event includes clustering a plurality of similar events, and associating the anomalous event with the cluster.

In addition to one or more of the features described herein, the contextual information includes at least one of an identity context, a temporal context, a location context and a situational context.

In addition to one or more of the features described herein, the machine learning model is a domain-specific large language model configured to output a diagnostic report including a plain language description of the anomalous event and the root cause.

In addition to one or more of the features described herein, the large language model is configured to interact with a user and provide diagnostic information in response to questions posed by the user using retrieval-augmented generation (RAG).

In addition to one or more of the features described herein, the method includes actively training the large language model based on identified anomalous events and associated contextual information, wherein the training includes iteratively presenting questions to machine learning model.

In addition to one or more of the features described herein, the machine learning model includes a graph machine learning (GML) model configured to correlate the anomalous event with the contextual information, the GML model is configured to generate a consolidated list of anomalous events, and each of the anomalous events is assigned a significance score.

In addition to one or more of the features described herein, the GML model generates a context graph including a plurality of nodes, the plurality of nodes including a node for an anomalous event and a node for each context specified by the contextual information, and the GML model performs a link prediction to determine a contextual correlation between the plurality of nodes.

In addition to one or more of the features described herein, identifying the anomalous event is performed using an anomaly detection machine learning model.

In addition to one or more of the features described herein, performing the mitigating action includes at least one of: presenting an alert to a user, vehicle control system or remote entity; applying a correction or update to the software system; and controlling operation of the vehicle.

In another exemplary embodiment, a system for diagnosing a software system includes a data collection module configured to receive data from the software system, and a root cause analysis tool configured to identify an anomalous event based on a pattern of the received data, collect contextual information related to the anomalous event, input the anomalous event and the contextual information to a machine learning model, and determining a root cause of the anomalous event by the machine learning model based on the contextual information.

In addition to one or more of the features described herein, the contextual information includes at least one of an identity context, a temporal context, a location context and a situational context.

In addition to one or more of the features described herein, the machine learning model is a domain-specific large language model configured to output a diagnostic report including a plain language description of the anomalous event and the root cause.

In addition to one or more of the features described herein, the large language model is configured to interact with a user and provide diagnostic information in response to questions posed by the user using retrieval-augmented generation (RAG).

In addition to one or more of the features described herein, the root cause analysis tool is configured to actively training the large language model based on identified anomalous events and associated contextual information, wherein the training includes iteratively presenting questions to machine learning model.

In addition to one or more of the features described herein, determining the root cause includes generating a context graph including a plurality of nodes, the plurality of nodes including a node for an anomalous event and a node for each context specified by the contextual information, and performing context graph embedding for input to the large language model.

In yet another exemplary embodiment, a vehicle system includes a memory having computer readable instructions, and a processing device for executing the computer readable instructions, the computer readable instructions controlling the processing device to perform a method including receiving data from a software system of a vehicle, identifying an anomalous event based on a pattern of the received data, collecting contextual information related to the anomalous event, inputting the anomalous event and the contextual information to a machine learning model, and determining a root cause of the anomalous event by the machine learning model based on the contextual information.

In addition to one or more of the features described herein, identifying an anomalous event includes clustering a plurality of similar events, and associating the anomalous event with the cluster.

In addition to one or more of the features described herein, the contextual information includes at least one of an identity context, a temporal context, a location context and a situational context.

In addition to one or more of the features described herein, the machine learning model is a domain-specific large language model configured to output a diagnostic report including a plain language description of the anomalous event and the root cause.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including various processing devices, in accordance with an exemplary embodiment;

FIG. 2 depicts a computer system, in accordance with an exemplary embodiment;

FIG. 3 depicts a software observability system, in accordance with an exemplary embodiment;

FIG. 4 depicts a root cause analysis (RCA) tool, in accordance with an exemplary embodiment;

FIG. 5 depicts components of the RCA tool and aspects of anomaly detection and contextual correlation performed by the RCA tool of FIG. 4, in accordance with an exemplary embodiment;

FIG. 6 depicts aspects of a method of correlating anomalous events identified from software telemetry data with contextual information, in accordance with an exemplary embodiment;

FIG. 7 depicts an example of the method of FIG. 6;

FIG. 8 depicts aspects of generating contextual information used by the RCA tool of FIG. 4, in accordance with an exemplary embodiment;

FIG. 9 depicts aspects of in-context active learning by a machine learning model used by the RCA tool of FIG. 4, in accordance with an exemplary embodiment;

FIG. 10 depicts an example of a 5-Whys visualization, which may be included as part of a diagnostic report generated by the RCA tool of FIG. 4; and

FIG. 11 depicts aspects of interaction between a specialist and a machine learning model of the RCA tool of FIG. 4, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Devices, systems and methods are provided for observing software systems and diagnosing system anomalies based on data collected from a vehicle system and contextual information. An embodiment of a system is configured to analyze software data (e.g., telemetry data, source code, documentation, event logs, historical records of incidents or anomalies, etc.), and identify anomalous events from patterns in the data. “Software data” or “received data” refers to any data collected from a software system and/or data related to operation of the software system, which can be used to evaluate the performance of the software system and/or components thereof.

The system collects contextual information, which is used to characterize identified anomalous events and/or determine whether such events represent an actual malfunction or condition that should be corrected or addressed (e.g., an error, fault or other sub-optimal operation, or any significant abnormal behavior).

In an embodiment, the contextual information includes an identity context, a temporal context, a location or spatial context and/or a situational context. In an embodiment, the contextual information and detected anomalous events are input to a machine learning model, such as a large language model, for determination of potential underlying or root causes and contributing factors. In an embodiment, the machine learning model is configured to output plain language descriptions of events, anomalies, potential root causes and/or suggested actions, as well as any other relevant or useful information.

Embodiments described herein present numerous advantages and technical effects. In complex systems such as vehicle systems, there is often a potentially large number of potential causes of an anomaly. As a result, identification of the actual root cause(s) of the anomaly can be difficult and time consuming. The embodiments provide an efficient system for automatically recognizing root causes and/or providing root cause information to a user, in an explainable manner so that human users can comprehend the detection process and trust the results. The embodiments reduce both the time and complexity associated with diagnostics.

Other advantages include enhanced ability to handle noisy log events and reduce alert fatigue, and shorter mean time to resolve/remediation (MTTR). In addition, embodiments may be used to build, update or use a knowledge base to facilitate identification of underlying causes and contributing factors. The knowledge base can be continuously or periodically updated; for example, the knowledge base is an evolving knowledge base (EKB).

Embodiments can also enhance existing platforms used for identifying malfunctions or anomalies, and used for root cause analysis. For example, there are existing software observability platforms for aggregating and visualizing telemetry data, identifying issues, recognizing root causes, and enabling troubleshooting. Embodiments enhance such systems by providing contextual analysis, which results in improved recognition of causes of detected events, as well as improved correlation of detected events to real problems.

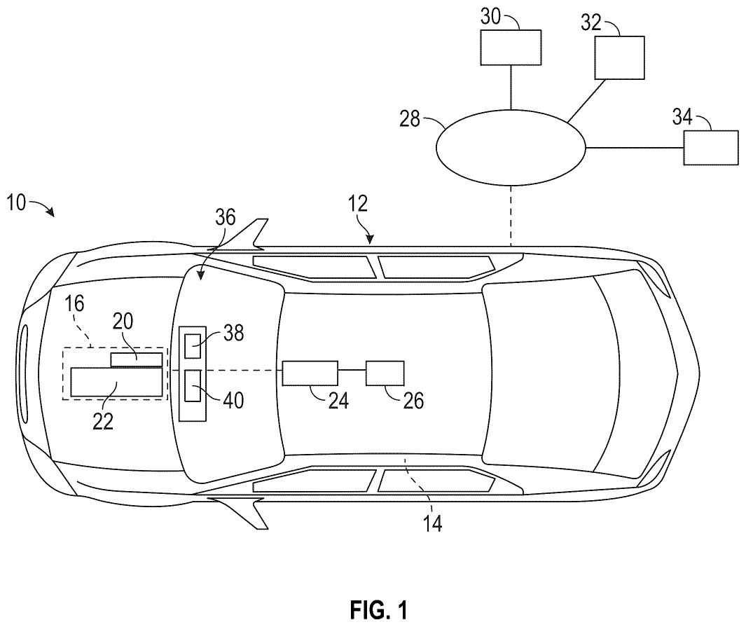

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a fuel system, a braking system, a suspension system, a steering subsystem, an exhaust system and others.

The vehicle may be a combustion engine vehicle, an electrically powered vehicle (EV) or a hybrid vehicle. In an example, the vehicle 10 is a hybrid vehicle that includes a combustion engine 20 and an electric motor 22.

The vehicle also includes various control systems for controlling aspects of vehicle systems. For example, one or more electronic control units (ECUs) 24 are provided. Aspects of the diagnostic and control methods described herein may be performed by any suitable controller or processing device, such as the ECU 24 and/or controllers in respective subsystems.

An embodiment of the vehicle 10 includes devices and/or systems for communicating with other vehicles and/or objects external to the vehicle. For example, the vehicle 10 includes a communication system having a telematics unit 26 or other suitable device including an antenna or other transmitter/receiver for communicating with a network 28.

The network 28 represents any one or a combination of different types of suitable communications networks, such as public networks (e.g., the Internet), private networks, wireless networks, cellular networks, or any other suitable private and/or public networks. Further, the network 28 can have any suitable communication range associated therewith and may include, for example, global networks (e.g., the Internet), metropolitan area networks (MANs), wide area networks (WANs), local area networks (LANs), or personal area networks (PANs). The network 28 can communicate via any suitable communication modality, such as short range wireless, radio frequency, satellite communication, or any combination thereof.

In an embodiment, the network 28 connects the vehicle 10 for communication with various entities. For example, the network 28 may be connected to a server 30, databases 32 and/or other remote entities 34 such as workstations, control centers, other vehicles and others.

The vehicle 10 also includes a computer system 36 that includes one or more processing devices 38 and a user interface 40. The various processing devices and units may communicate with one another via a communication device or system, such as a controller area network (CAN) or transmission control protocol (TCP) bus.

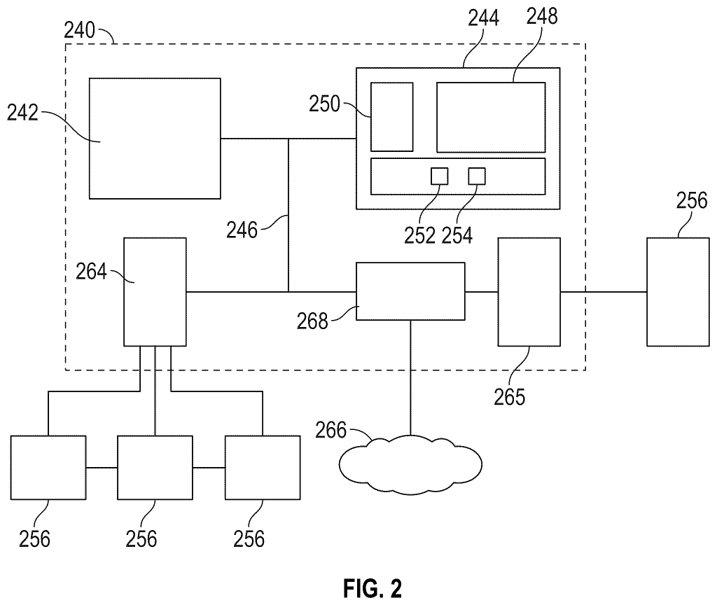

FIG. 2 illustrates aspects of an embodiment of a computer system 240 that can perform various aspects of embodiments described herein. The computer system 240 includes at least one processing device 242, which generally includes one or more processors for performing aspects of image acquisition and analysis methods described herein.

Components of the computer system 240 include the processing device 242 (such as one or more processors or processing units), a memory 244, and a bus 246 that couples various system components including the system memory 244 to the processing device 242. The system memory 244 can be a non-transitory computer-readable medium, and may include a variety of computer system readable media. Such media can be any available media that is accessible by the processing device 242, and includes both volatile and non-volatile media, and removable and non-removable media.

For example, the system memory 244 includes a non-volatile memory 248 such as a hard drive, and may also include a volatile memory 250, such as random access memory (RAM) and/or cache memory. The computer system 240 can further include other removable/non-removable, volatile/non-volatile computer system storage media.

The system memory 244 can include at least one program product having a set (i.e., at least one) of program modules that are configured to carry out functions of the embodiments described herein. For example, the system memory 244 stores various program modules that generally carry out the functions and/or methodologies of embodiments described herein. A module 250 may be included for performing functions related to acquiring signals and data, and a module 252 may be included to perform functions related to anomaly detection and diagnostics as discussed herein. The system 240 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 242 can also communicate with one or more external devices 256 as a keyboard, a pointing device, and/or any devices (e.g., network card, modem, etc.) that enable the processing device 242 to communicate with one or more other computing devices. Communication with various devices can occur via Input/Output (I/O) interfaces 264 and 265.

The processing device 242 may also communicate with one or more networks 266 such as a local area network (LAN), a general wide area network (WAN), a bus network and/or a public network (e.g., the Internet) via a network adapter 268. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

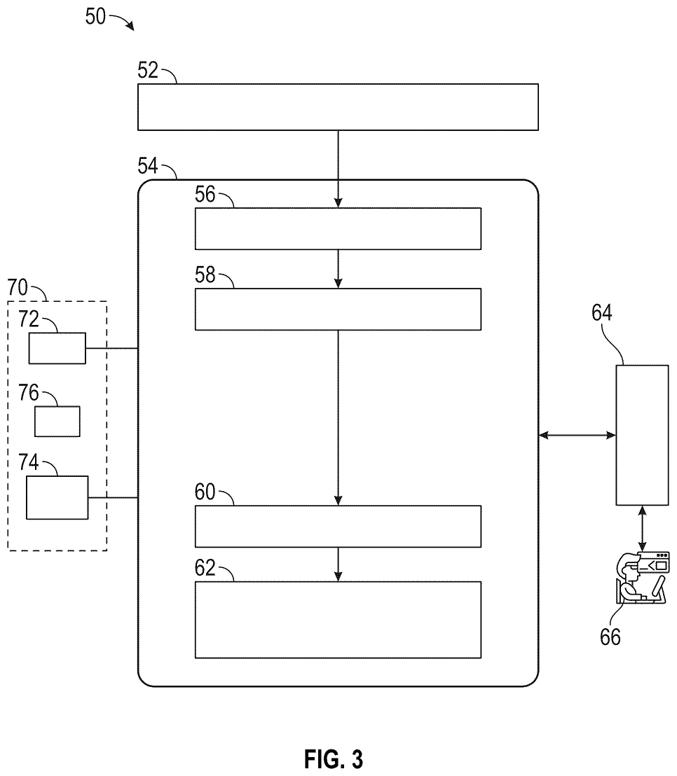

FIG. 3 depicts an embodiment of a software monitoring or observability system 50 for monitoring software systems for detection of anomalies and/or determining root causes of anomalies. “Software observability” refers to the ability to infer a software system's internal states from knowledge of the software system's external outputs. The software monitoring system 50 may be embodied in any suitable processing device or system, such as the computer system 240, the vehicle computer system 36 and/or the ECU 24.

The observability system 50 acquires output data from a device or system, such as telemetry or monitoring data related to software components. It is noted that, although the software components are described as software used by the vehicle 10 and/or software used in relation to vehicle operation, embodiments are applicable to any suitable software system.

The observability system 50 includes a data collection module 52 configured to collect telemetry data, which may be any form of data related to software performance. Examples of telemetry data include metrics, traces, logs and profiles.

The data collection module 52 inputs collected data to a software observability platform 54 for aggregating and visualizing telemetry data, identifying issues, recognizing root causes, and enabling troubleshooting. The platform 54 is able to provide insights into the internal state of a software system during runtime, allowing developers and operators to understand the software system's behavior, diagnose issues, and optimize performance.

The observability platform 54 includes processing components or modules for performing functions related to monitoring and diagnostics. For example, the observability platform 54 includes a monitoring module 56 that continuously or periodically receives software data (e.g., metrics used in descriptive analytics, distributed traces, event logs, reports, etc.) and provides the received data to an anomaly identification module 58. The anomaly identification module 58 correlates data patterns with issues or anomalies. Examples of such anomalies include outages, performance bottlenecks, errors and others.

A root cause analysis module 60 determines underlying or root causes and/or factors that contribute to an anomaly or issue. A module 62 may be included that recommends corrective actions to address the anomaly or issue. Such corrective actions may be provided to correct the anomaly, contain the anomaly or otherwise address or remediate the anomaly.

An interface is provided to allow a user to interact with the observability platform 54. For example, an operational dashboard 64 is accessible by a user, such as a technician, site reliability engineer (SRE) or other software specialist 66. Generally, a “specialist” refers to any person or entity that has expertise in the software system(s) being monitored.

The observability system 50 includes or is connected to one or more components that provide for context-based anomaly detection and root cause determination. For example, a contextual root cause analysis (RCA) tool 70 is in communication with components of the observability platform 54. Although the contextual RCA tool 70 is shown as a separate module or system, embodiments are not so limited, as the RCA tool 70 (or components thereof) may be incorporated into the observability platform 54 directly.

In an embodiment, the contextual RCA tool 70 includes an anomaly detection and contextual correlation module 72 (also referred to as a “detection and correlation module”) that detects anomalies based on patterns in the collected data, and correlates detected anomalies with contextual information. The detection and correlation module 72, in an embodiment, includes or is configured as a machine learning model (anomaly detection model) that learns data patterns indicative of various anomalies).

Contextual information, in an embodiment, is acquired by a context analysis module 74 or context analyzer. The context analyzer 74 collects any information suitable for determining a context in which the telemetry data was collected. A “context” or “contextual information” refers to any information that characterizes the situation, environment or condition in which an anomaly occurs. The contextual information allows the observability platform and/or RCA tool 70 to characterize an anomaly in the received data, and/or determine whether an anomaly in the received data corresponds to an actual problem or issue with monitored software.

The detection and correlation module 72 and the context analyzer 74, in an embodiment, provide inputs to a machine learning model 76, such as a large language model (LLM). The machine learning model 76 may be a generalized LLM, or may be a finetuned model trained for a specific domain and/or include frozen layers that restrict training data to make the model 76 domain-specific.

Aspects of the observability system 50 may be included or stored at various locations. For example, the data collection module 52 may be disposed in the vehicle 10, and the observability platform is stored in the server 30. The observability system 50 includes an interface, such as the operational dashboard 64, stored at a workstation 34 and usable by a site reliability engineer (SRE), technician, dealership, telematics live advisor or other user.

In use, the observability system 50 receives data collected from a software system, and analyzes the received data to identify one or more anomalous events (i.e., anomalies) based on patterns in the collected data. Anomalous events are consolidated and fed to the machine learning model 76. Contextual information is provided and fed to the machine learning model 76, which characterizes the anomalous events (e.g., describes the specific context in which an anomaly arises), and/or determines whether one or more anomalous events is indicative of a malfunction or otherwise should be addressed or remediated. The machine learning model 76 outputs a plain language report to a user, which summarizes any detected anomalies and their contexts, describes root causes and other underlying factors, and may offer solutions or suggested actions. In an embodiment, a user can interact with the machine learning model 76 to input questions and receive plain language answers.

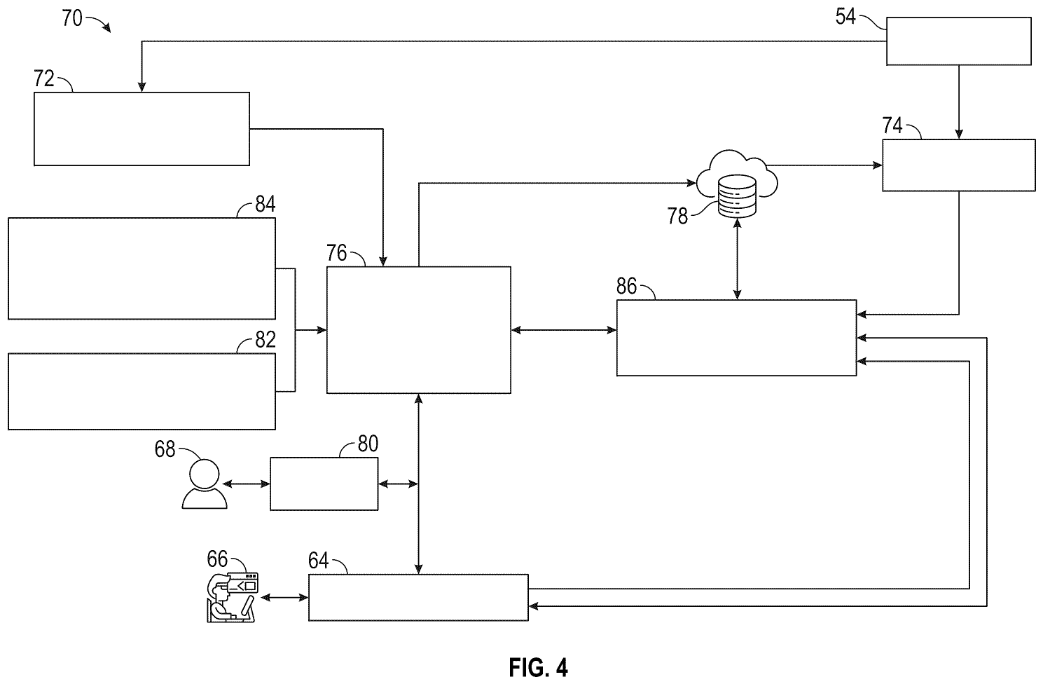

FIG. 4 schematically depicts an embodiment of the RCA tool 70 and aspects of a method of root cause analysis. In this embodiment, the context analyzer 74 provides contextual information, which includes a description or indication of various contexts (e.g., type of vehicle, geographic location, etc.), and may also include reference data. The reference data indicates data patterns that are considered to be associated with abnormal operation, and/or data patterns that are associated with normal operation, for various contexts.

The context analyzer 74 determines the context based on any suitable information. For example, a user can input contextual information (e.g., via the operational dashboard 64) and/or the context analyzer 74 can infer the context from a combinations of inputs. Reference data may be acquired from a suitable source, such as a knowledge base 78.

“Contextual information” encompasses any data or information that allows the RCA tool 70 to characterize or categorize anomalous events or otherwise determine whether an anomalous event is benign or is reflective of an underlying problem. The contextual information includes, for example, textual descriptors regarding a situation associated with the event (e.g., from event logs), temporal information (e.g., when the event occurred, frequency of the event, seasonality, etc.), event names or other identifiers, and location information.

Contextual information and anomalous events are provided to the model 76, such as an LLM 76. The LLM 76 outputs a description of any detected anomalies, as well as the context and one or more root causes and/or underlying factors as determined by the LLM 76. For example, the LLM 76 outputs a diagnostic report 80 that includes a plain language summary of an anomaly, the context associated with the anomaly and/or its associated root cause or causes. The diagnostic report 80 may follow a template such as an RCA template 82 that provides a format for the report. Other templates may be used for interacting with a user, such as a question and answer (Q&A) template 84.

For example, the diagnostic report 80 includes a plain language summary of a problem or anomaly, along with a list of root causes and any other contributing factors. In an embodiment, the diagnostic report 80 includes a visualization (which may be interactive) such as a word cloud or display of results of a “5-Whys” interactive analysis (which allows the LLM 76 to ask a series of questions in order to build a knowledge/causal graph or otherwise build causation information).

A knowledge/causal graph is a graph-structured data type that evolves over time and captures various aspects of metadata (e.g., detected events, underlying causes, and contributing factors). Additionally, the knowledge/causal graph may encode interaction data, representing causal effects that allow for understanding relationships and dynamics within a software system.

The diagnostic report 80 may be output to the specialist 66 (e.g., SRE) via the operational dashboard 64. The specialist 66 can interact with the operational dashboard 64 and/or the diagnostic report 80 to ask questions and provide information as described herein.

The diagnostic report 80 may also be provided to one or more other users 68 (e.g., vehicle owner, live advisor, service staff, etc.). In an embodiment, the other user(s) 68 can interact with the diagnostic report 80 to give the other user(s) 68 the ability to ask questions for further elaboration. Giving access to external users (e.g., in addition to the specialist 66) can enrich causal information, as these users may have different perspectives. A default setting may be provided that limits bi-directional communication to only the specialist 66.

In an embodiment, the RCA tool 70 includes a learning module 86. The learning module 86 is used for active in-context learning. The learning module 86 may also include capability for a user to interact with the LLM 76 to pose questions and retrieve information. In an embodiment, the learning module 86 provides a large language model enhancement technique for improving or enhancing answers and information provided in response to user questions. An example of such a technique is retrieval-augmented generation (RAG), which enhances accuracy and relevance of questions from a user by accessing external information (i.e., information not already accounted for in the LLM 76). For example, in response to a user (e.g., the specialist 66 or other user 68) inputting questions, the learning module 86 queries an external source, such as the knowledge base 78, to enhance answers.

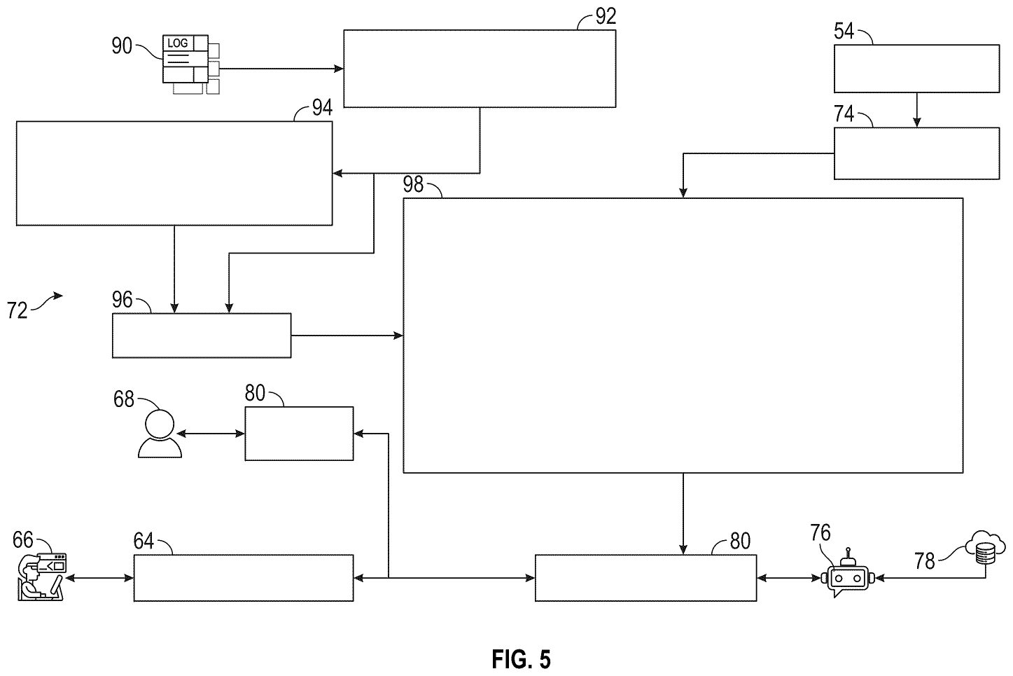

FIG. 5 depicts components of an embodiment of the anomaly detection and correlation module 72. FIG. 5 also depicts aspects of use of the detection and correlation module 72 in correlating anomalies with contextual information.

The detection and correlation module is configured to receive telemetry and/or other software data such as stream logs 90, and input the stream logs 90 to an event parser 92. The event parser 92 structures and categorizes events in the stream logs 90. The structured and categorized events are input to an unsupervised pattern recognition model 94, which learns patterns for each type of log event and outputs structured log events.

The pattern recognition model 94 is used to build a baseline for each type of log event, and these baselines are used to detect anomalies (represented by anomaly detection 96). Anomaly detection 96 involves receiving log events from the parser 92, and comparing a pattern in each log event to a respective baseline pattern. If the log event pattern does not match the baseline (e.g., differs from the baseline by more than a threshold amount, or otherwise deviates from the baseline pattern), the log event is identified as an anomalous event.

Anomalous events are collected and analyzed to correlate the events with contextual information (contextual correlation 98). For example, anomalous events are compared to stored anomalies. In another example, anomalous events are correlated with their temporal aspects (e.g., peak time or seasonality) and/or geographical aspects (e.g., geographic location). In an embodiment, similar events may be clustered to identify correlated clusters of anomalies across stream logs (or other data files), to reduce noise and/or identify core events.

The contextual correlation 98 associates each anomalous event with one or more contexts. Outputs and information from the contextual correlation are provided to the LLM 76 for characterizing the anomalous events. “Characterizing” an anomalous events may include indicating whether the anomalous event is normal or abnormal, and identifying one or more root causes if the anomalous event is abnormal.

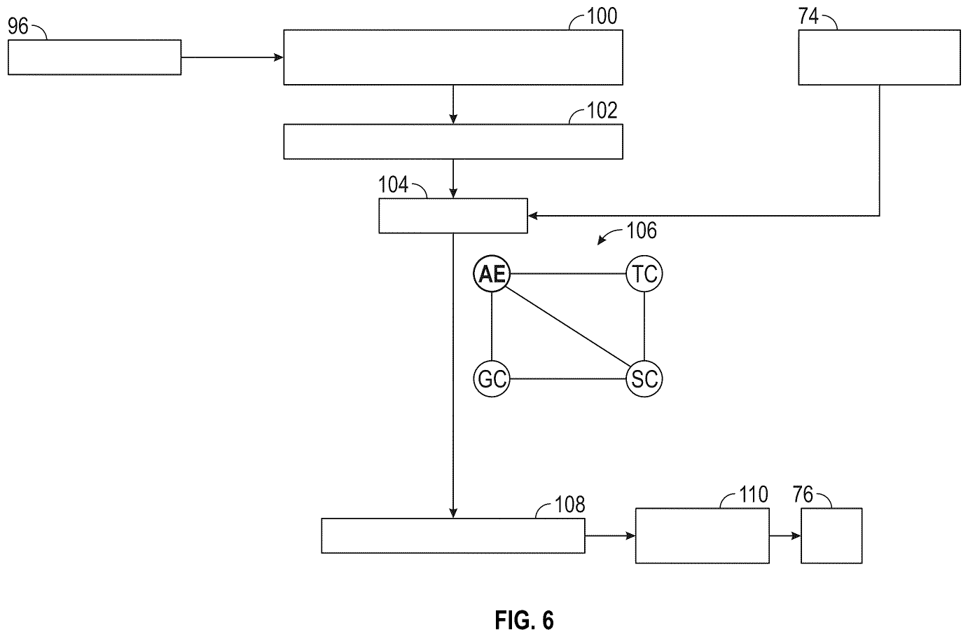

FIG. 6 shows an example of correlation performed by the detection and correlation module 72. Anomaly detection 96 is performed as discussed herein based on learned baselines and events. Anomalous events may be categorized by rareness and severity (block 100), and similar events are clustered (block 102).

Each anomalous event may be assigned a score (referred to as a “significance score”) based on how significant an anomalous event is, using various criteria such as rareness and severity. “Rareness” refers to how rare an anomalous event is, where a high rareness corresponds to a higher significance score (e.g., a higher score will be given to an event that occurs for the first time). “Severity” reflects how bad or severe the anomalous event is (e.g., events with higher severities will get higher significance scores than events with lower severities). Severity can be quantified based on the deviation of an anomalous event from a baseline, and a duration of this deviation. High deviation and longer persistency lead to higher severity (and a higher confidence score), as compared to instantaneous or shorter duration and/or low deviation. An event that is both rare and severe will get a higher total score than an event that is only severe or only rare.

Contextual information from the context analyzer 74 is correlated with the anomalous event (or cluster of anomalous events). In an embodiment, contextual information includes an identity context, a temporal context, a location or spatial context and/or a situational context.

“Identity context” is related to the identity and capability of the vehicle 10 (e.g., vehicle identification number, manufacturer information). “Temporal context” refers to the timing and/or frequency of an abnormal event occurring. “Spatial context” refers to a geographic location and/or spatial location (e.g., geolocation or GPS). “Situational context” refers to any condition or situation that impacts whether an anomalous event is abnormal (e.g., vehicle health condition). Other contextual information may include “spatiotemporal context” reflective of changes in both time and space (e.g., timing and location changes in, for example, social events).

In the example of FIG. 6, at block 104, the anomalous events and contextual information are incorporated put into a context graph (block 104). A context graph 106 is constructed to incorporate the clustered anomalous events, situational context such as similar current or previous anomalies, temporal context such as peak time or seasonality and spatial context for geo-anomaly.

The context graph 106 includes a node for a given anomalous event or cluster of similar events. In addition, the context graph 106 includes a node for each context provided by the contextual information. Nodes are linked via links or edges that represent a relation between the nodes.

In the example of FIG. 6, the context graph 106 includes a node AE representing clustered anomalous events, a node TC for temporal context, a node SC for situational context, and a node GC for geospatial context. Each node includes one or more node features xᵢ. For example, the node AE includes identifying information such as an identifier (“id”) and/or vehicle identification number (“vin”), and a metric from the telemetry data. The node GC may include spatial information such as geographic location, GPS coordinates and others. The TC node may include time information (e.g., specific day/time, seasonality, etc.). Situational information in the SC node may include similar or previous events or anomalies.

Graph machine learning-based graph embedding (block 108) is generated to learn a mapping from a discrete high-dimensional graph domain to a low-dimensional continuous domain. This graph embedding 108 can be generated using one or more graph machine learning (GML) models such as a graph neural network, a convolutional graph network (CGN) and/or a graph attention network (GAT) to convert the context graph 106 into feature vectors for further inductive reasoning tasks. Attention mechanisms can be also used to significantly improve task models by selectively weighting the importance of different components of the context graph 106. Link prediction (block 110) is performed to recognize the contextual correlation (links) between the nodes. The resulting anomalous event information and contextual correlation are then provided to the LLM 76 for determination as to root causes. For example, the GML model(s) provide a consolidated list of anomalous events, along with respective significance scores and contextual correlations.

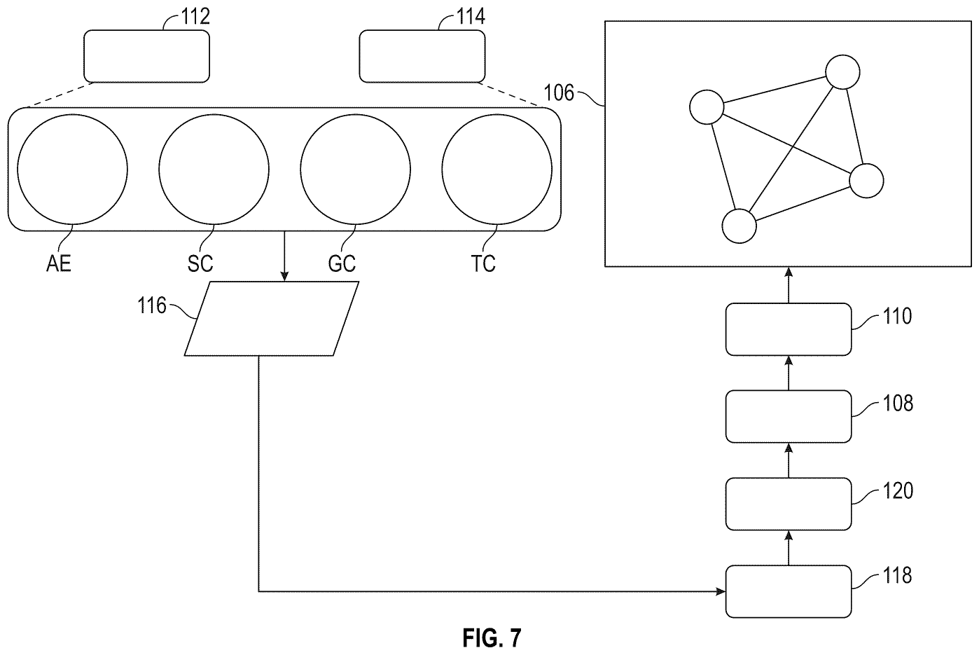

FIG. 7 shows an example of generating the context graph 106. In this example, telemetry data includes metrices 112 and associated event logs 114. The metrices 112 are formulated into tabular data and the event logs 114 are used to create word embeddings for the LLM 76, and the tabular data and word embeddings are used to generate nodes, such as the nodes AE, SC, GC and TC. Edges are initially randomly assigned (block 116), and negative sampling (block 118) and unsupervised contrastive loss learning (block 120) are used to generate the graph embedding 108. The graph embedding 108 is provided for link prediction 110, and node information and link prediction 110 results are used to construct the context graph 106.

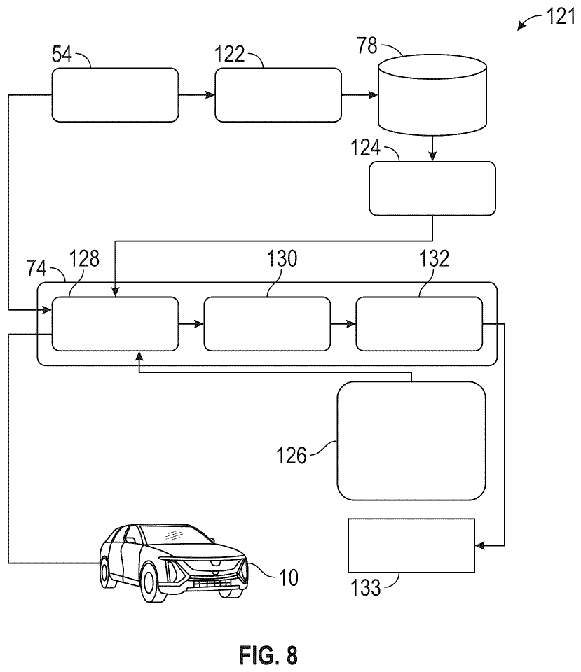

FIG. 8 depicts an embodiment of a method 121 performed by the context analyzer 74. When determining context associated with received data, the received data (e.g., telemetry data including metrics and event logs) are input from the observability platform 54 to the context analyzer 74. In addition, a semantic search (block 122) of the knowledge base 78 is performed to acquire a set of contextual data 124.

The context analyzer 74 receives information and data from the vehicle 10 (e.g., health condition, diagnostic codes, battery status, data drift information, etc.), as well as any interaction data from active learning (block 126). Content filtering is performed to remove irrelevant information (block 128), and contextual information is identified (block 130) and extracted (block 132). The contextual information (shown as element 133) is output to, for example, the detection and correlation module 72 and/or the LLM 76 (FIG. 4).

The following is an example of interpretation of information to generate contextual information 133. Generally, the contextual information 113 includes one or more contexts and reference data used to determine the contexts.

In this example, the context analyzer 74 receives information in the form of average RAM utilization (68% in the past 12 hours), performance data including CPU usage (0.2%) and vehicle speed (zero). The context analyzer 74 also receives identification information (vehicle identification number (vin), a device identifier, and version and log identifier) and location information.

Based on these inputs, the context analyzer 74 determines the identity context (vehicle identification data), the temporal context (past 12 hours), spatial context and situational context. In this example, the situational context is “high memory usage while CPU utilization is low and the vehicle is at standstill.”

The contexts and reference data are then provided to the LLM 76. The LLM 76 also receives anomalous event data related to the high RAM utilization. The LLM 76 interprets a root cause as a “possible memory leak.” The root cause and the contextual information 133 may be provided to a user, such as the specialist 66. The specialist 66 may also interact with the LLM 76 to ask questions or answer questions and further probe for root causes of the high RAM utilization.

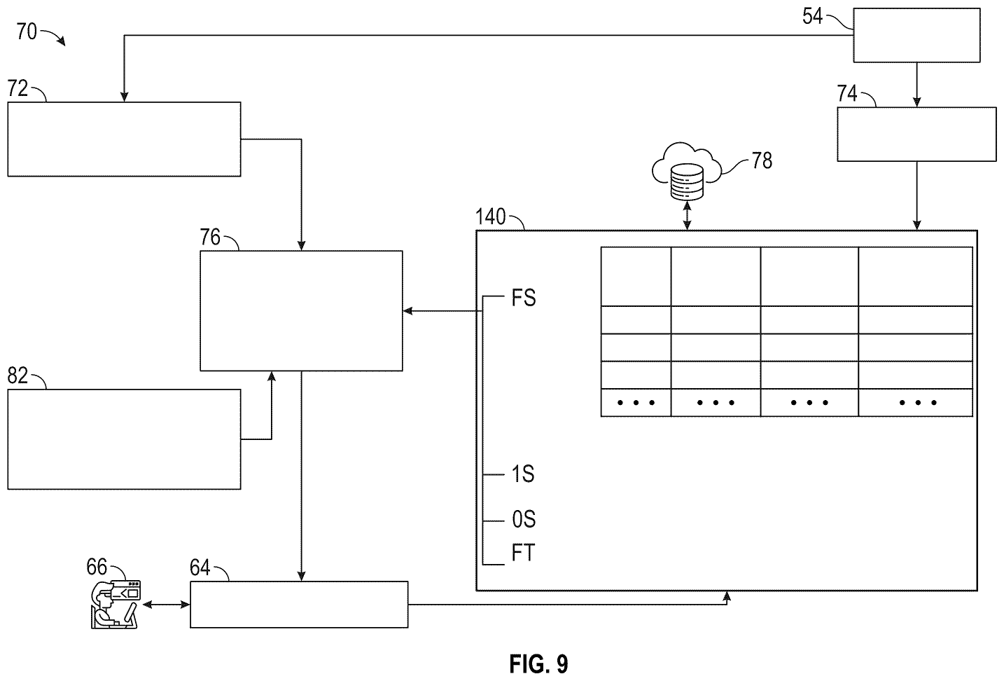

FIG. 9 depicts an embodiment in which the LLM 76 is configured to actively learn underlying causes and contributing factors to various anomalies or anomalous events in various contexts. This in-context active learning (block 140) may be used to build or enhance the knowledge base 78.

In an embodiment, active learning 140 is achieved by way of interacting with an SRE or other specialist 66. In an embodiment, active learning 140 involves questioning and answering (“question-answering”). An example of an active learning process is a “5-Whys” methodology, which involves answering a series of five questions (or other desired or suitable number of questions).

Active learning 140 may include other root-cause analysis methods such as Fishbone Diagram (Ishikawa Diagram), Fault Tree Analysis (FTA), Failure Mode and Effects Analysis (FMEA). Such methods may be performed in conjunction with question-answering. For example, question-answering can support an FMEA process through initial screening to identify common failure modes for a specific software component and/or to identify trends and patterns that could be helpful in understanding root causes if historical data for such failure modes is available.

In an embodiment, the active learning is based on the 5-Whys root cause analysis methodology, which is an iterative process that helps identify the root cause of a problem and elicit knowledge to be used later for identification of underlying causes and contributing factors. During each iteration, the LLM 76 generates a question (i.e., why is an identified anomaly occurring?), and generates an answer. Results of the 5-Whys analysis may be presented to the specialist 66 (and/or other user) to provide confidence as to the LLM's 76 root cause determination. It is noted that embodiments are not limited to 5-Whys analysis, as any suitable analytical method can be used that provides insight into the LLM's 76 reasoning.

Learning in a specific context can involve utilizing a static LLM with Few-Shot (FS), One-Shot (1S), or Zero-Shot (0S) configurations, or alternatively, fine-tuning (FT) the LLM 76. In the FS approach, the LLM 76 is presented with a small number of task demonstrations during inference, serving as conditioning, without updating any weights. These demonstrations include K instances of context and completion of root cause determination, followed by a single context example, with the LLM 76 expected to generate the corresponding completion. The 1S approach is akin to the FS approach, but with K set to 1. The 0S approach mirrors FS, but instead of examples, a natural language description of the task is presented to the LLM 76. Fine-tuning (FT) involves updating the weights of a pre-trained model through training on a multitude of supervised labels specific to an intended task. Fine-tuning entails adjusting the weights of a pre-existing model by exposing it to extensive training with numerous supervised labels tailored to the targeted task.

A report, such as the diagnostic report 80 (FIG. 4) includes a plain language summary of an anomaly or anomalies, and a list or other description of underlying root causes and contributing factors. The report 80 may also include a word cloud, display of 5-Whys analysis results and/or any other visualization. The RCA report may include an interactive visualization.

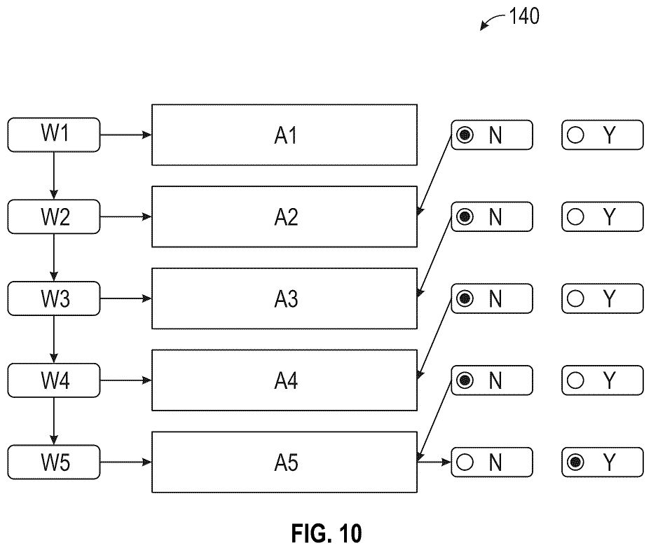

FIG. 10 depicts an example of a visualization 140 of a result of an interactive 5-Whys analysis that may be provided to the specialist 66 via the operational dashboard 64. In this example, an identified anomaly is found, in the form of increased central processing unit (CPU) usage at a vehicle bus level. The visualization 144 shows a series of five “why” questions (denoted as W1, W2, W3, W4 and W5), where each why question asks why the anomaly has occurred. Each why question was generated by the LLM 76 and also answered by the LLM 76. In FIG. 10, an answer A1 to the first why question W1 is “increased overhead,” an answer A2 to the second why question W2 is “large number of running apps,” an answer A3 to the third why question W3 is “rolling out a new version or a configuration update,” an answer A4 to the fourth why question W4 is “to handle recently detected security and data breaches,” and an answer A5 to the fifth why question W5 is “detected shadow and zombie APIs.” A section denoted “Root Cause?” indicates whether an answer is a root cause.

The specialist 66 may interact with the operational dashboard 64 to provide answers for the 5-Whys analysis (e.g., if the LLM 76 is unable to generate and answer a sufficient number of questions during 5-Whys analysis), to allow the specialist 66 to provide knowledge to the RCA tool 70, and/or to allow the specialist 66 to ask questions.

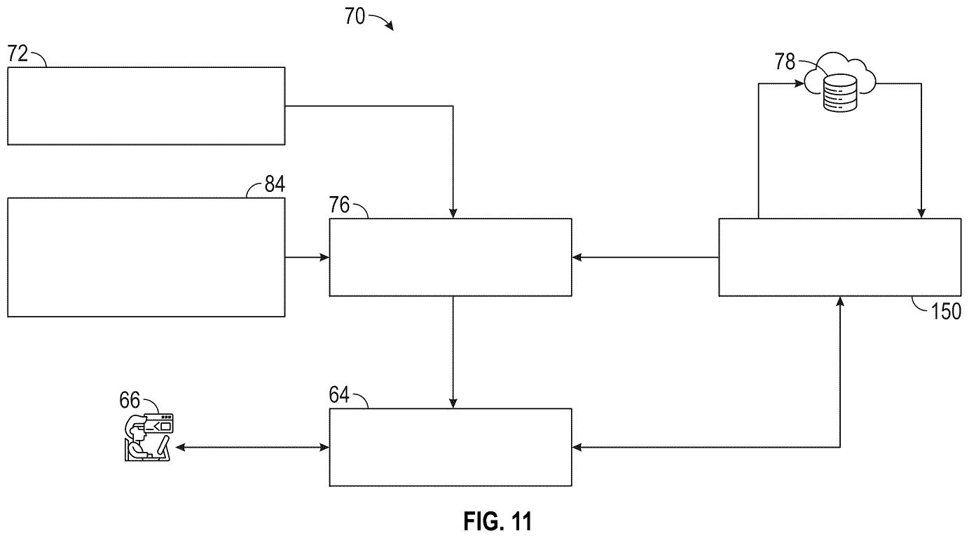

FIG. 11 depicts an embodiment of the RCE tool 70, and depicts aspects of interaction between the specialist and the RCA tool 70. As shown, the specialist 66 can interact with the operational dashboard 64 to ask questions of the LLM 76. The LLM 76, in an embodiment, is configured to answer questions and may enhance the answers by querying external sources of information, such as the knowledge base 78. For example, the LLM 76 is a general purpose LLM, and is configured to use retrieval-augmented generation (RAG) 150 to enable the LLM 76 to provide domain-specific answers to questions asked by the specialist 66. RAG is not limited to use with a general purpose LLM (e.g., RAG can be used to enhance answers by a domain-specific LLM). In addition, the RCA tool 70 may be configured to allow other users 68 to ask questions.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of diagnosing a software system of a vehicle, comprising:
receiving data related to the software system of the vehicle;
identifying an anomalous event based on a pattern of the received data;
collecting contextual information related to the anomalous event;
inputting the anomalous event and the contextual information to a machine learning model;
determining a root cause of the anomalous event by the machine learning model; and
based on determining that the anomalous event corresponds to a malfunction, performing a mitigating action.

2. The method of claim 1, wherein identifying the anomalous event includes clustering a plurality of similar events, and associating the anomalous event with the cluster.

3. The method of claim 1, wherein the contextual information includes at least one of an identity context, a temporal context, a location context and a situational context.

4. The method of claim 1, wherein the machine learning model is a domain-specific large language model configured to output a diagnostic report including a plain language description of the anomalous event and the root cause.

5. The method of claim 4, wherein the large language model is configured to interact with a user and provide diagnostic information in response to questions posed by the user using retrieval-augmented generation (RAG).

6. The method of claim 4, further comprising actively training the large language model based on identified anomalous events and associated contextual information, wherein the training includes iteratively presenting questions to machine learning model.

7. The method of claim 1, wherein the machine learning model includes a graph machine learning (GML) model configured to correlate the anomalous event with the contextual information, the GML model is configured to generate a consolidated list of anomalous events, and each of the anomalous events is assigned a significance score.

8. The method of claim 7, wherein the GML model generates a context graph including a plurality of nodes, the plurality of nodes including a node for an anomalous event and a node for each context specified by the contextual information, and the GML model performs a link prediction to determine a contextual correlation between the plurality of nodes.

9. The method of claim 1, wherein identifying the anomalous event is performed using an anomaly detection machine learning model.

10. The method of claim 1, wherein performing the mitigating action includes at least one of:
presenting an alert to a user, vehicle control system or remote entity;
applying a correction or update to the software system; and
controlling operation of the vehicle.

11. A system for diagnosing a software system, comprising:
a data collection module configured to receive data from the software system; and
a root cause analysis tool configured to perform:
identifying an anomalous event based on a pattern of the received data;
collecting contextual information related to the anomalous event;
inputting the anomalous event and the contextual information to a machine learning model; and
determining a root cause of the anomalous event by the machine learning model based on the contextual information.

12. The system of claim 11, wherein the contextual information includes at least one of an identity context, a temporal context, a location context and a situational context.

13. The system of claim 11, wherein the machine learning model is a domain-specific large language model configured to output a diagnostic report including a plain language description of the anomalous event and the root cause.

14. The system of claim 13, wherein the large language model is configured to interact with a user and provide diagnostic information in response to questions posed by the user using retrieval-augmented generation (RAG).

15. The system of claim 13, wherein the root cause analysis tool is configured to actively train the large language model based on identified anomalous events and associated contextual information, wherein the training includes iteratively presenting questions to machine learning model.

16. The system of claim 13, wherein determining the root cause includes generating a context graph including a plurality of nodes, the plurality of nodes including a node for an anomalous event and a node for each context specified by the contextual information, and performing context graph embedding for input to the large language model.

17. A vehicle system comprising:
a memory having computer readable instructions; and
a processing device for executing the computer readable instructions, the computer readable instructions controlling the processing device to perform a method including:
receiving data from a software system of a vehicle;
identifying an anomalous event based on a pattern of the received data;
collecting contextual information related to the anomalous event;
inputting the anomalous event and the contextual information to a machine learning model; and
determining a root cause of the anomalous event by the machine learning model based on the contextual information.

18. The vehicle system of claim 17, wherein identifying an anomalous event includes clustering a plurality of similar events, and associating the anomalous event with the cluster.

19. The vehicle system of claim 17, wherein the contextual information includes at least one of an identity context, a temporal context, a location context and a situational context.

20. The vehicle system of claim 17, wherein the machine learning model is a domain-specific large language model configured to output a diagnostic report including a plain language description of the anomalous event and the root cause.
